(19) United States
(12) Patent Application Publication
(10) Pub. No.: US 2007/0239832 A1
(43) Pub. Date: Oct. 11, 2007

(54) Communication presentation in a calendar perspective

(75) Inventors: Jurdan Alperin, Denver, CO (US); Rich Cerami, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 11/399,096

(22) Filed: Apr. 5, 2006

(51) Int. Cl. G06F 15/16; G06F 17/00; G06F 15/00

(52) U.S. Cl. 709/206; 715/500

(57) ABSTRACT

Systems, methods, and machine-readable media are disclosed to provide presentation of communication records in a calendar perspective. In one embodiment, a method of presenting records of communications in a calendar perspective can comprise receiving from a user a request to view communications to or from the user. One or more stored communication records can be read. Each record can represent a communication to or from the user and can include information related to the communication. A calendar page can be generated for displaying the communication records. A graphical indication for each of the communication records can be inserted into the calendar page into the calendar page. The calendar page can then be displayed to the user.

### CROSS REFERENCE TO RELATED APPLICATIONS

This application is related to co-pending U.S. patent application Ser. No. 11/255,089 entitled “Cross-Platform Support for a Variety of Media Types” filed Oct. 19, 2005, and U.S. patent application No. entitled “Cross-Platform Calendar Notifications” filed contemporaneously herewith, (Attorney Docket No. 020366-098800US) both of which are herein incorporated by reference.

### BACKGROUND OF THE INVENTION

Embodiments of the present invention relate generally to communications networks and more particularly to allowing presentation of communication records in a calendar perspective.

Today it is very common, and probably the norm, for an individual to have and regularly use a number of communications devices of different types that communicate via a variety of different media. For example, an individual may, on a daily basis, use a number of different telephones such as a work line, a home line, one or more cell phones, etc. Additionally, this same individual may have and use a number of other communications devices and/or media such as one or more email accounts, one or more instant message accounts, etc. that are accessible through any of a number of different devices such as personal computers various portable devices, and/or other network attached devices that communicate via the Internet or other network.

However, keeping track of communications that occur through these different devices or via these different media can be difficult. Each device or medium may individually provide a way to view a log or record of communications that occur through that particular device or media. For example, a cell phone may present a call log of past incoming and/or outgoing calls. In another example, an email program may present incoming and/or outgoing emails in a log represented as a list. However, these logs are only a list of communications via that particular device and/or medium. They do not allow for viewing communications occurring on any other device or medium such that a user can see communications occurring on multiple devices and/or media in a single view. Furthermore, such individual logs, presented as a list of communications via a single device or medium are not very informative. More specifically, they do not allow a user to easily and intuitively correlate communications via different devices or media. Hence, there is a need for methods and systems that provide a unified, easy to read presentation of communications occurring via multiple devices and/or media.

### BRIEF SUMMARY OF THE INVENTION

Systems, methods, and machine-readable media are disclosed to provide presentation of communication records in a calendar perspective. In one embodiment, a method of presenting records of communications in a calendar perspective can comprise receiving from a user a request to view communications to or from the user. One or more stored communication records can be read. Each record can represent a communication to or from the user and can include information related to the communication. A calendar page can be generated for displaying the communication records. According to another embodiment, the method can further comprise reading one or more calendar items for the user. In such a case, generating the calendar page can comprise generating a calendar page including the one or more calendar items. A graphical indication for each of the communication records can be inserted into the calendar page. In some cases, prior to inserting the graphical indication for each of the communication records into the calendar page, the communication records can be ordered based on a time of occurrence of the communication determined from each of the communication records. The calendar page can then be displayed to the user.

According to one embodiment, the method can further comprise determining one or more requested communication types from the request to view communications. In such a case, reading the communication records can comprise reading one or more communication records representing communications of the requested communication types. Alternatively or additionally, the method can comprise determining a requested time period from the request to view communications. In such a case reading the communication records can comprise reading one or more communication records representing communications occurring during the requested time period and generating a calendar page can comprise generating a calendar page spanning the requested time period.

According to another embodiment, the method can further comprise detecting a communication to or from the user. A new communication record can be generated for the detected communications and information related to the communication can be recorded in the new communication record. The information related to the communication can include, but is not limited to, a communication type, a start time for the communication, an indication of the duration of the communication, an indication of another party to the communication, etc.

According to yet another embodiment, the method can further comprise, in response to the user selecting one of the graphical indications, displaying additional details of a communication record indicated by the graphical indication. In some cases, displaying additional details of a communication selected by the user can comprise displaying a tooltip, a pop-up window, an overlay, or other structure or control including information from the communication record indicated by the selected graphical indication. In some cases, such a structure or control can also include one or more options for handling the communication record based on a type of communication represented by the communication record.

According to still another embodiment, a system can comprise a communications bus and a user profile database communicatively coupled with the communications bus. The user profile database can be adapted to maintain profile information for a plurality of users, the profile information including one or more communication records each representing a communication to or from the user and including information related to the communication. The system can also include at least one end device communicatively coupled with the communications bus. The end device can be adapted to send and receive common language messages via the communications bus, to translate common language messages received from the communications bus to a format specific to the end device based on a device type, and to store user profile information in the user profile database. The system can include a manager communicatively coupled with the communications bus. The manager can be adapted to receive from the end device a request to view communications to or from a user of the end device, read one or more stored communication records from the profile information for the user of the end device, generate a calendar page for displaying the communication records, insert a graphical indication for each of the communication records into the calendar page, and send the calendar page to the end device via the bus. The end device can be further adapted to receive the calendar page from the manager and to display the calendar page to the user.

According to another embodiment, the manager can be further adapted to detect a common language message to or from the user of the end device, generate a new communication record for the detected common language message, record information related to the common language message in the new communication record, and store the new communication record in the profile information for the user of the end device. The information related to the communication can include, but is not limited to, a communication type, a start time for the communication, an indication of the duration of the communication, an indication of another party to the communication, etc.

According to yet another embodiment, a machine-readable medium can have stored thereon a series of instruction which, when executed by a processor, cause the processor to present records of communications in a calendar perspective by receiving from a user a request to view communications to or from the user, reading one or more stored communication records wherein each record represents a communication to or from the user and includes information related to the communication, generating a calendar page for displaying the communication records, and inserting a graphical indication for each of the communication records into the calendar page.

### BRIEF DESCRIPTION OF THE DRAWINGS

FIG. 1 is a block diagram illustrating, at a high-level, functional components of an architecture for providing presentation of communication records in a calendar perspective according to one embodiment of the present invention.

FIG. 2 is a block diagram illustrating functional component of an architecture for providing presentation of communication records in a calendar perspective according to an alternative embodiment of the present invention.

FIG. 3 is a block diagram illustrating an exemplary computer system in which embodiments of the present invention may be implemented.

FIG. 4 illustrates an exemplary user interface for presenting communication records in a calendar perspective according to one embodiment of the present invention.

FIG. 5 illustrates the exemplary user interface for presenting communication records in a calendar perspective as illustrated in FIG. 4 with additional communication details according to one embodiment of the present invention.

FIG. 6 illustrates the exemplary user interface for presenting communication records in a calendar perspective as illustrated in FIG. 4 with additional communication details according to an alternative embodiment of the present invention.

FIG. 7 is a flowchart illustrating a process for recording communications to be present in a calendar perspective according to one embodiment of the present invention.

FIG. 8 is a flowchart illustrating a process for presenting communication records in a calendar perspective according to one embodiment of the present invention.

FIG. 9 is a flowchart illustrating additional details of a process for presenting communication records in a calendar perspective according to an alternative embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Embodiments of the present invention provide methods, system and machine-readable media for presenting records of communications in a calendar perspective to provide a unified view of communications occurring via multiple devices and/or media. As will be described in detail below, a communication to or from the user can be detected by a system monitoring such communications. A new communication record can be generated for the detected communication. Information related to the communication can be recorded in the new communication record. The information related to the communication can include, but is not limited to, a communication type, a start time for the communication, an indication of the duration of the communication, an indication of another party to the communication, etc.

A request to view communications to or from a user can be received from the user. The stored communication records fro that user can be read. A calendar page can be generated for displaying the communication records. According to one embodiment, one or more calendar items for the user can also be read. In such a case, generating the calendar page can comprise generating a calendar page that includes the one or more calendar items. A graphical indication for each of the communication records can be inserted into the calendar page. The calendar page can then be displayed to the user.

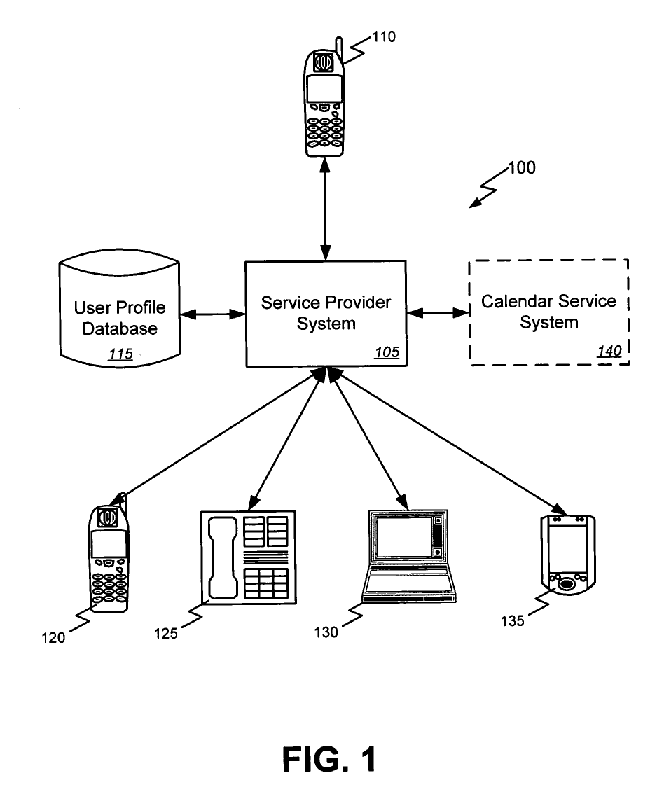

FIG. 1 is a block diagram illustrating, at a high-level, functional components of an architecture for providing presentation of communication records in a calendar perspective according to one embodiment of the present invention. In this example, the system 100 includes an initiating device 110 communicatively coupled with a service provider system 105. The service provider system 105 is communicatively coupled with a user profile database 115 and a plurality of recipient devices 120-135. Generally speaking, the initiating device 110 can initiate a communication such as a telephone call to one of the recipient devices 120-135 through the service provider system 105.

Initiating device 110 can be any of a number of possible communication devices. While illustrated here as resembling a cell phone, initiating device can also be a land line telephone, a Personal Digital Assistant (PDA), any of a variety of wireless devices, a personal computer, etc. Regardless of the exact type of device, initiating device 110 can be communicatively coupled with service provider system 105 via typical communication media such as a cellular network, a land line telephone, a Local Area Network (LAN), Wide Area Network (WAN), the Internet, or other type of network. Through this communication media, initiating device 110 can send and receive communications to and from the service provider system 105.

Service provider system 105 can be one or more systems adapted to provide communications services of one or more types to the initiating device 110. For example, service provider system 105 can be a system providing cellular telephone services, land line telephone services, Internet services, etc. Service provider system 105 can be adapted to send and receive communications of an appropriate type to and from initiating device 110.

User profile database 115 can be communicatively coupled with service provider system 105 via a Local Area Network (LAN), Wide Area Network (WAN), the Internet, or other type of network or other communications media. While user profile database 115 is shown in this example as being separate from the service provider system 105, the user profile database may be internal or external to the service provider system 105 or may be part of and/or maintained by another system and may be either local to or remote from the service provider system 105. Regardless of the exact configuration, user profile database 115 maintains a set of user profile data or preferences for one or more users of the service provider system 105 such as a user of initiating device 110 and/or users of recipient devices 120-135. For example, the user profile database 115 may include information relating to call features such as call forwarding or other information relating to other types of communications such as email delivery options.

The system 100 can also optionally include calendar service system 140. If used, calendar service system can set and/or track calendar events for the various devices or users. That is, when a request to set a calendar event is received from the initiating device 110, the calendar service system can set a timer or other event based on the information from the request. Alternatively, if the calendar service system 140 is not used, the service provider system 105 can be used to set and/or track calendar events for the various devices or users. Additionally or alternatively, the calendar service system 140 or service provider system 105 can be adapted to monitor communications between end devices, record information about these communications in the user profile database 115, and upon a request from a user, present communication records in a calendar perspective as will be described below.

Recipient devices 120-135 can be any of a number of possible communication devices. For example, recipient devices can be cell phones, land line telephones, Personal Digital Assistants (PDAs), any of a variety of wireless devices, Personal Computers (PCs), etc. Regardless of the exact types of devices, recipient devices 120-135 can be communicatively coupled with service provider system 105 via typical communication media such as a cellular network, a land line telephone, a Local Area Network (LAN), Wide Area Network (WAN), the Internet, and/or other types of networks. Through this communication media recipient devices 120-135 can send and receive communications to and from the service provider system 105.

Importantly, while referred to herein as a recipient device or an initiating device for the sake of explanation, any device coupled with the service provider system 105 can potentially, at various times, act as either an initiating device or a recipient device. For example, a particular cell phone may at one point initiate a call but at another time may receive a call. Therefore, the labels of initiating device and recipient device are illustrative only and indicate only a particular device's function at a specific point in time rather than indicating any limits on its functionality overall.

In use, the service provider system 105 can receive from the initiating end device 110 a communication to one the recipient end devices 120-135. The communication can be detected by the service provider system 105 and/or the calendar service system. The service provider system 105 or the calendar service system 140 can generate a new communication record for the detected communication. Information related to the communication can be recorded in the new communication record. The information related to the communication can include, but is not limited to, a communication type, a start time for the communication, an indication of the duration of the communication, an indication of another party to the communication, i.e., the user of the initiating device 110 or identifying information for the initiating device 110, etc. Such information can be stored by the service provider system 105 or the calendar service system 140 in the user profile database 115 as part of profile information for the user of the recipient device.

A user of a recipient device 130 can later request a record of communications. The request to view communications to or from a user can be received from the recipient device 130 by the service provider system 105 or the calendar service system 140. The stored communication records for that user can be read by the service provider system 105 or the calendar service system 140 from the user profile database 115. A calendar page can be generated by the service provider system 105 or the calendar service system 140 for displaying the communication records. According to one embodiment, one or more calendar items for the user can also be read from the user profile database. In such a case, generating the calendar page can comprise generating a calendar page that includes the one or more calendar items. A graphical indication for each of the communication records can be inserted into the calendar page by the service provider system 105 or the calendar service system 140. The page can be provided by the service provider system 105 or calendar service system 140, for example, in the form of a web page or other format to the recipient device 130. The calendar page can then be displayed by the recipient device 130 to the user.

According to one embodiment, the service provider system 105 or calendar service system 140 can determine one or more requested communication types from the request to view communications. That is, the user of the recipient device 130 can request certain types of communications, such as emails, phone calls, Instant Messages (IMs), etc, or all communications. In such a case, when the service provider system 105 or calendar service system 140 reads the communication records from the user profile database 115, it can read one or more communication records representing communications of the requested communication types. Alternatively or additionally, the service provider system 105 or calendar service system 140 can determine a requested time period from the request to view communications. That is, the user of the recipient device 130 can request communications from a certain time period such as a give day or period. In such a case, when the service provider system 105 or calendar service system 140 reads the communication records from the user profile database 1 15, it can read one or more communication records representing communications occurring during the requested time period. Also, when the service provider system 105 or the calendar service system 140 generates a calendar page, it can generate a calendar page spanning the requested time period, i.e., the request day, week, month, or other period.

Alternatively, another architecture that provides support for communications between a number of different devices of different types may be used to provide the same functions. Such an architecture is described in the above referenced, co-pending U.S. patent application titled “Cross Platform Support for a Variety of Media Types.” While not necessary to implement various embodiments of the present invention, such an architecture is considered useful with embodiments of the present invention since it provides a communication bus that in turn provides a common representation, in the form of a number of common language messages, of services or information available to, from, and between end devices regardless of the type of end device or the server providing or receiving the information or service. Furthermore, the architecture includes a central user profile database that can be used to store information related to related to calendar notification features such as discussed above. An overview of this architecture is now provided for convenience.

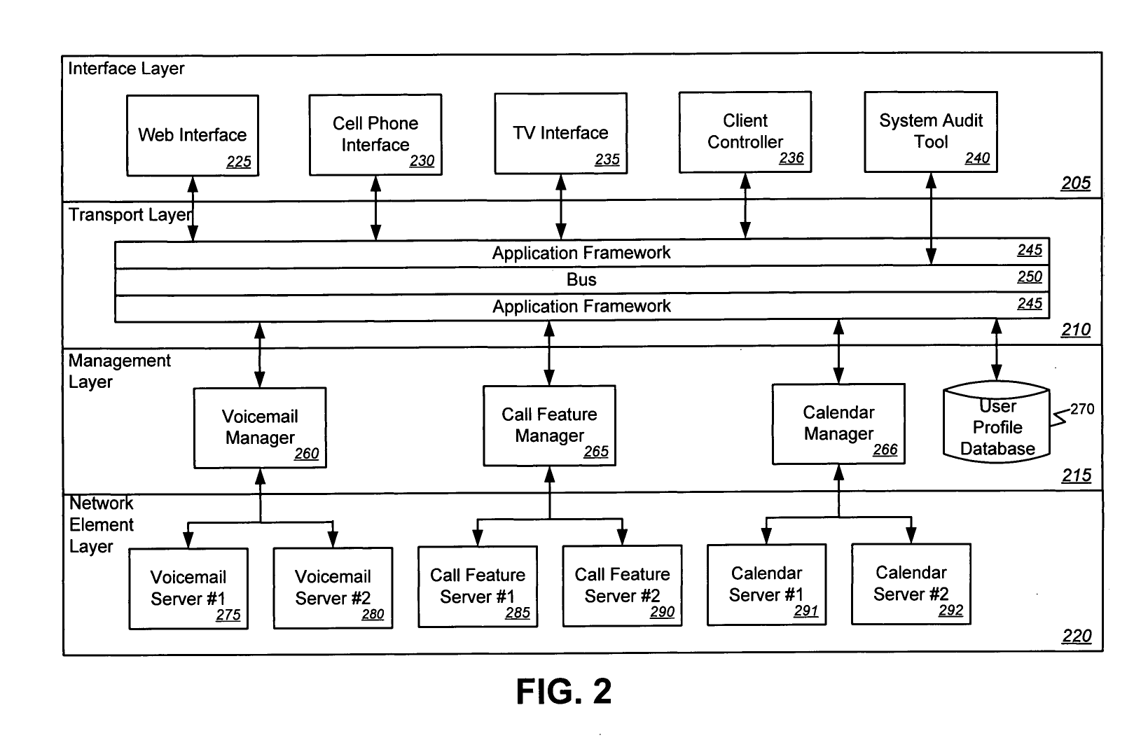

FIG. 2 is a block diagram illustrating functional component of an architecture for providing presentation of communication records in a calendar perspective according to an alternative embodiment of the present invention. In this example, the architecture is logically divided into four layers 205-220. The layers 205-220 include a network element layer 220, a management layer 215, a transport layer 210, and an interface layer 205. As will be seen, elements of each layer 205-220 can be communicatively coupled with elements of the next layer 205-220. So, elements of the network element layer 220 can be communicatively coupled with elements of the management layer 215 which in turn can be communicatively coupled with elements of the transport layer 210, etc.

The network element layer 220 can comprise one or more servers 275-290. The servers 275-290 of the network element layer 220 can each provide content and/or services of one or more types. For example, one or more servers 275 and 280 may provide voicemail services while one or more other servers 285 and 290 provide one or more call features such as call forwarding, caller ID, etc. Importantly, while this example shows a limited number of servers 275-290 in the network element layer 220, many more servers, providing a wide range of content or services of various types may be included. For example, one or more servers may be included for providing Internet services, television (TV) services, Email services, and various other types of data, communication, and/or entertainment services.

The management layer 215 can comprise one or more managers 260 and 265. Each manager 260 and 265 can be communicatively coupled with one or more of the servers 275-290 of the network element layer 220. For example, voicemail manager can be coupled with voicemail servers 275 and 280 while call feature manager 265 can be coupled with call feature servers 285 and 290. Importantly, while managers 260 and 265 and servers 275-290 are shown and described herein as being organized by or arranged per service, other arrangements are contemplated and considered to be within the scope of the present invention. According to one alternative, the managers 260 and 265 and the servers 275-290 may be arranged by company or provider. So, for example, one manager may be coupled with and provide access to the services and content provided by the servers of company A while another manager may be coupled with and provide access to the services and content provided by the servers of company B. However, an arrangement of managers 260 and 265 and servers 275-290 based on service and/or content type may be preferable since, as will be seen, such an arrangement can provide for easier extensibility of the system when adding features or services.

Furthermore, as noted above, additional servers may be used in the network element layer providing additional services and/or content of different types. Therefore, more, fewer, or different managers than shown in this example may be used in an actual implementation. For example an additional manager may be used for interfacing with one or more servers providing TV services or email services. In another example, one or more managers may be communicatively coupled with one or more servers tracking billable events on the architecture. That is, one manager may track calls, messages, events, or pay-per-view or other content billed on a per-use basis so that the appropriate users can be billed by the operator of the architecture, the provider of the content, and/or other parties.

According to one embodiment, the management layer 215 can include a calendar manager 266 and the network element layer 220 can include one or more calendar servers 291 and 292. As will be seen, the calendar manager 266 and calendar servers 291 and 292 can be used to read requests for calendar events from end devices, save event definition information in the profile information for the requesting user, set and detect the occurrence of calendar events, and inform one or more end devices of this occurrence. Additionally or alternatively, the calendar manager 266 or other manager can be adapted to monitor communications between end devices, record information about these communications in the user profile database 270, and upon a request from a user, present communication records in a calendar perspective as will be described below.

Regardless of the exact number, nature, or organization of the servers 275-290 and managers 260 and 265, the managers 260 and 265 can be adapted to translate content of the servers 275-290 with which the manager 260 and 265 is connected from the media types of the servers 275-290 to one or more common language messages. That is, the managers 260 and 265 can provide translation from a service specific format to a common or generic format. For example, voicemail server #1 275 and voicemail server #2 280 may be operated by different entities and offer different information in different formats that may be completely incompatible with each other. However, voicemail manager 260 provides for translating these different functions, formats, etc into a common language message that can be used by all other elements of the architecture.

According to one embodiment of the present invention, the managers 260 and 265 can provide defined interfaces to the servers 275-290 of the network element layer 220. By using calls, invocations, requests, or other signals or messages to the managers 260 and 265, the servers 275-290 can pass content or messages to the managers 260 and 265 for translation to a common language message for transmission to another element of the architecture. For example, voicemail manager 260 may provide an Application Program Interface (API) for use by any voicemail server 275 and 280 connected with the voicemail manager 260. Voicemail servers 275 and 280 can then use API calls to the voicemail manager 260 to initiate services, pass content or other information, and/or otherwise communicate with the voicemail server 260. According to one embodiment of the present invention, calls to the API or other interface may be closely analogous to the common language messages generated by the manager. For example, as will be described in detail below, the manager may generate “InitiateCommunication” message to initiate a communication. The manager's API may also provide a “InitiateCommunication” or other similar call to the servers to which it is connected through which the servers can initiate a communication.

While use of an API or other defined interface between the managers 260 and 265 and the servers 275-290 is not required, it may be preferred since, by using an API or other type of defined interface, the managers 260 and 265 can be easily extended or modified as services and/or content of the servers are added or changed or as new servers are added. That is, the use of a defined interface such as an API allows greater extensibility since the only changes made at the manager would be to add or modify an appropriate “stub,” module, or routine to add a new server, service, or content type without a need to make wholesale changes or re-write the managers.

According to one embodiment of the present invention, the manager and the API or interface of the manager may be implemented using object-oriented programming techniques. In such a case, the manager API calls made by the servers can cause the stub or module of the manager interfacing with the server to instantiate an object of a particular class type, such as a “InitiateCommunication” object, with properties representing, among other possibilities, the content of data to be communicated, the intended recipient(s), etc. Such an object or common language message may be defined in a common format readable by other elements of the architecture. For example, the object may be defined in an extensible Markup Language (XML) file. The manager can then transmit this object or common language message to any or all of the other elements of the architecture via the transport layer 210.

The transport layer 210 can comprise a communications bus 250 communicatively coupled with each of the managers 260 and 265. The bus 250 can be adapted to receive and transport the one or more common language messages from the managers 260 and 265. The transport layer 210 can also comprise an optional application framework 245 interposed between the end devices 225-236 of the interface layer 205 and the communications bus 250 and between the managers 260 and 265 and the communications bus 250. Generally speaking, the application framework 245 provides for monitoring and tracking of the common language messages placed on the bus 250 of the transport layer 210.

Regardless of whether the application framework 245 is used, the bus 250 of the transport layer 210 comprises a common representation of data that is usable by all elements of the architecture. Furthermore, the bus 250 provides this message to any or all devices in the architecture as appropriate regardless of the type of device.

According to one embodiment of the present invention, the bus 250 may also be implemented using object-oriented programming techniques. In such a case, a manager placing or sending a common language message on the bus 250 can call or invoke an API or other interface of the bus 250 or otherwise cause the instantiation of an object of a particular class type, such as a “InitiateCommunication” object, with properties representing, among other possibilities, the content of data to be communicated, the intended recipient(s), etc. The bus can then make this object or common language message available to any or all of the other elements of the architecture.

The interface layer 205 of the architecture can comprise one or more end devices 225-236 of different types. For example, the end devices 225-236 can represent a cell phone 230, a web browser 225, a TV interface 235, etc all potentially operating on different platforms with different operating systems. Each end device 225-236 can be communicatively coupled with the bus 250 of the transport layer, either directly or via the application framework 245, and can be adapted to receive and translate the common language messages to a format specific to the end device based on its type.

Alternatively or additionally, one or more of the end devices may comprise a client controller 236 communicatively coupled with the bus 250 of the transport layer 210 and one or more other end devices (not shown here) such as a personal computer, television Set-Top Box (STB), telephone, or other type of device. If used, the client controller 236can be adapted to receive common language messages from the bus 250, translate content from the common language messages to a format specific to the end device(s) for which it is intended, and deliver the device specific message to the device or devices. In some cases, the client controller 236 may also be adapted to act as a firewall for end devices communicating via the bus 250 of the transport layer 210.

That is, the end devices 225-236 can translate from the common language messages, such as an XML message, to device specific representations of the information in that message for presentation to user in whatever format that device uses. According to one embodiment, the translation functions of the end devices can also be implemented using object-oriented programming techniques. In such a case, the end devices receive the common language messages such as XML encoded representations of the objects on the bus 250 of the transport layer 210. Translation can therefore comprise instantiating on the end device an object of the class indicated by the message with the properties indicated by the message thereby translating the properties of the object on the bus to a presentation language of the device.

Thus far, the description of the architecture has focused on messages from the servers 275-290 to the end devices 225-236. However, the end devices 225-236 can also be adapted to generate one or more common language messages based on user input and send the one or more common language messages to one or more of the managers 260-265 via the bus 250. For example, a cell phone 230 or other end device 225-236 can generate a “InitiateCommunication” message to be sent to any or all of the managers 260-265 or even to another end device. Therefore, the managers 260-265 can be further adapted to receive the common language messages from the end devices 225-236 via the bus 250 and to translate the common language messages to content of the media type of the servers 275-290 with which the manager 260 and 265 is connected.

According to one embodiment of the present invention, the architecture can include a user profile database 270 communicatively coupled with the bus 250 of the transport layer. The user profile database 270 can be adapted to maintain records of a set of user preferences for one or more of the end devices 225-236 of the interface layer 205. For example, TV or cell phone settings or options for a particular device and/or a particular user can be stored in the user profile database 270 for retrieval by one or more of the end devices 225-236 or one or more of the managers 260 and 265. Therefore, he user profile database 270 can be adapted to provide the preferences to one or more of the end devices 225-236 or one or more of the managers 260 and 265 in response to a common language message received via the bus 250. In another example, the user profile database 270 can be adapted to store information related to calendar notification features. More specifically, user profile database 270 can include a list of phone numbers, device addresses, or other identifying information for one or more recipient devices that a user of an initiating device may wish to notify on the occurrence of a calendar event. In other words, the user profile database 115 can include an identifier, such as a phone number, email address, Internet Protocol (IP) address, instant message address, physical address, MAC address, etc for each of one or more possible recipient devices.

According to another embodiment of the present invention, the architecture can further comprise a system audit tool 240 communicatively coupled with the bus 250 of the transport layer 210. The system audit tool 240 can be adapted to monitor common language messages on the bus 250.

Therefore, in use, the bus 250 provides a common representation of services or information available to, from, and between the end devices 225-236 regardless of the type of end device or the server providing or receiving the information or service. This common representation is in the form of a number of common language messages. The type, number, format, etc. of the common language messages can vary widely depending upon the exact implementation without departing from the scope of the present invention. However, for illustrative purposes only, some exemplary messages will be described.

According to one embodiment, the common language messages can include a “InitiateCommunication” request message indicating a request to initiate a communication. Similarly, the common language messages can include a “InitiateCommunication” response message acknowledging initiation of a communication. According to another embodiment, the common language messages can include a “Call Information” request indicating a request for information relating to a communication and a “Call Information” response providing requested information. The common language messages can also include a “Communication Record Request” message to request a calendar displaying communication records.

The various types of message can take any of a variety of possible formats without departing from the scope of the present invention. However, for illustrative purposes only, an exemplary format for a message may be considered to include a header and a body. The header may include information such as any or all of: an address or other indication of the device or devices for which the message is intended; an address or other indication of the device originating the message; an indication of the message type; an indications of the type of contents in the message; etc. The message body may include information such as representation of or actual content to be transferred. Therefore, the body can contain an email message, an MP3 or MP4 audio or video file, a hyperlink or other direction to a location of the actual content, etc. However, once again, the exact format of the common language messages can vary widely depending on the exact implementation.

Regardless of the exact format, translating content to a common language message or generating a common language message can comprise generating a file, such as an XML file, of the appropriate format to indicate the type of message and the end devices for which it is intended and possibly an indication of the contents. Alternatively, as indicated above, various components of the architecture may be implemented using object-oriented programming techniques. In such a case, generating a common language message can comprise instantiating an object of a particular class type, such as a “InitiateCommunication” object, with properties representing, among other possibilities, the content of data to be communicated, the intended recipient(s), etc.

In use, the calendar manager 266 or other manager can detect common language messages such as “InitiateCommunication” messages to one or more of the end devices 255-240 of the interface layer 205. The manager 266 can generate a new communication record for the detected communication. Information related to the communication can be recorded in the new communication record. The information related to the communication can include, but is not limited to, a communication type, a start time for the communication, an indication of the duration of the communication, an indication of another party to the communication, i.e., the user of the initiating device or identifying information for the initiating device, etc. Such information can be stored by the manager 266 in the user profile database 270 as part of profile information for the user of the recipient device.

A user of a recipient device 225 can later request a record of communications. The request to view communications to or from a user can be received from the recipient device 225 by the calendar manager 266 or other manager. The stored communication records for that user can be read by the manager 266 from the user profile database 270. A calendar page can be generated by the manager 266 for displaying the communication records. According to one embodiment, one or more calendar items for the user can also be read from the user profile database 270. In such a case, generating the calendar page can comprise generating a calendar page that includes the one or more calendar items. A graphical indication for each of the communication records can be inserted into the calendar page by the manager 266. The page can be provided by the manager 266, for example, in the form of a web page or other format to the recipient device 255. The calendar page can then be displayed by the recipient device 266 to the user.

According to one embodiment, the manager 266 can determine one or more requested communication types from the request to view communications. That is, the user of the recipient device 255 can request certain types of communications, such as emails, phone calls, Instant Messages (IMs), etc, or all communications. In such a case, when the manager 266 reads the communication records from the user profile database 270, it can read one or more communication records representing communications of the requested communication types. Alternatively or additionally, the manager 266 can determine a requested time period from the request to view communications. That is, the user of the recipient device 225 can request communications from a certain time period such as a give day or period. In such a case, when the manager 266 reads the communication records from the user profile database 270, it can read one or more communication records representing communications occurring during the requested time period. Also, when the manager 266 generates a calendar page, it can generate a calendar page spanning the requested time period, i.e., the request day, week, month, or other period.

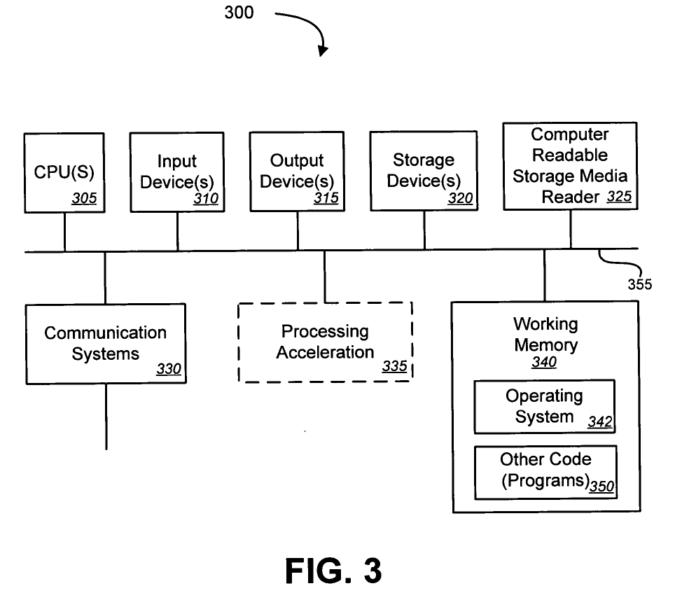

FIG. 3 is a block diagram illustrating an exemplary computer system in which embodiments of the present invention may be implemented. This example illustrates a computer system 300 such as may be used, in whole, in part, or with various modifications, to provide various components of the systems discussed above.

The computer system 300 is shown comprising hardware elements that may be electrically coupled via a bus 355. The hardware elements may include one or more central processing units (CPUs) 305, one or more input devices 310 (e.g., a mouse, a keyboard, etc.), and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325, a communications system 330 (e.g., a modem, a network card (wireless or wired), an infra-red communication device, etc.), and working memory 340, which may include RAM and ROM devices as described above. In some embodiments, the computer system 300 may also include a processing acceleration unit 335, which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with the network 320 and/or any other computer described above with respect to the system 300.

The computer system 300 may also comprise software elements, shown as being currently located within a working memory 340, including an operating system 445 and/or other code 350. It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

Software of computer system 300 may include code for code 350 for implementing any or all of the function of the various elements of the architecture as described herein. For example, software, stored on and/or executed by a computer system such as system 300, can provide the functions of the service provider system, a manager, an end device, etc. Methods implemented by software on some of these components will be discussed in detail below.

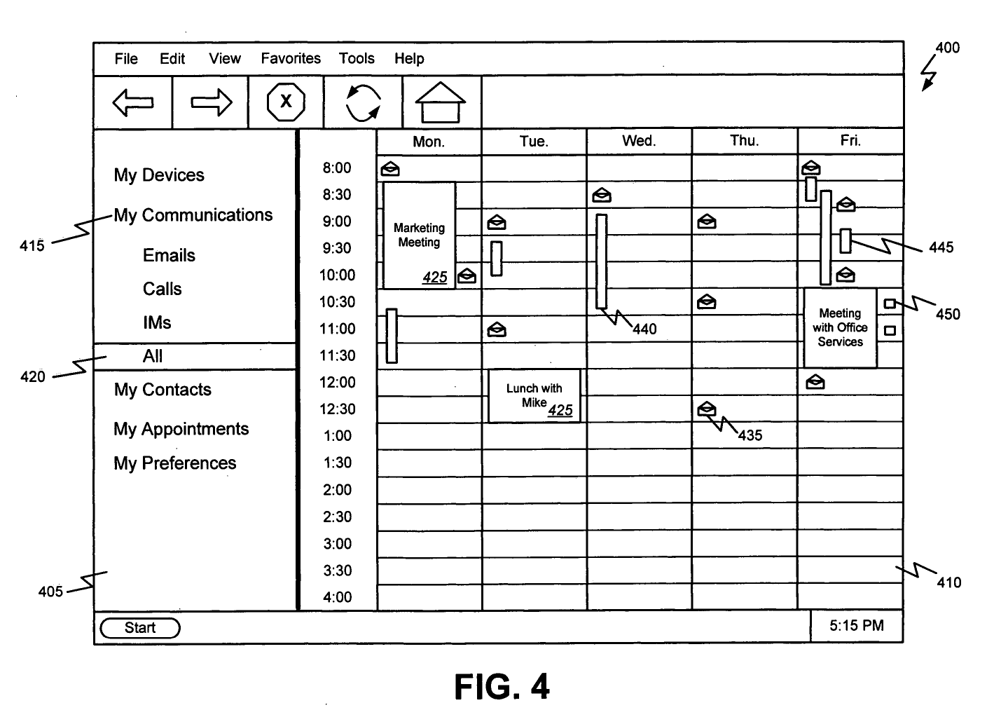

FIG. 4 illustrates an exemplary user interface for presenting communication records in a calendar perspective according to one embodiment of the present invention. In this example, the interface 400 is shown as a webpage as it may be presented in a browser window. The webpage includes a left or navigation frame 405 and a right frame 410 presenting a current view based on a selected element from the navigation frame 405.

The navigation frame 405 in this example includes a number of selections including a “My Communications” selection 415. Other possibilities may present options for controlling or monitoring end devices, setting and/or managing contact information, setting or managing calendar appointments, setting or managing other various user preferences, etc. Furthermore, the “My Communications” selection, as well as other selections, may have sub-selections or sub-menus. For example, the “My Communications” selection may have sub-selections for selecting the types of communications to be presented.

The selections from the navigation frame may comprise hyperlinks, clickable icons, or other elements. Furthermore, the currently selected item 420 from the navigation frame 405 may be highlighted or otherwise changed in appearance relative to the other selections.

In this example, the “All” sub-selection 420 of the “My Communications” selection 415 of the navigation frame has been selected. Therefore, the right frame 410 includes a calendar for a specified time period with the calendar including indications of appointments 425 and 430 or other calendar items as well as various communications 435-450 occurring during that period. The selected time period for the calendar may be based on a default period, such as the current day, the current week, etc., may be selected based on user preferences set through this or another interface, may be selected through the navigation frame 405 or through a pop-up window or other interactive element of the webpage 400 querying the user for a time period, or through any number of other means.

Regardless of how the period is selected, the calendar of the right frame 410 can display calendar appointments 425 and 430 for the user as well as well as graphical representations of communications 435-450 occurring during that period. The calendar items may be set and/or managed, for example, as described in the above references co-pending application entitled “Cross-Platform Calendar Notifications.”

In some cases, such as with emails 435 and/or perhaps voicemails that take little or no time for the user to receive, the communication may be presented by an icon or other representation that does not show a span of time on the calendar. Other communications, such as IMs, phone conversations, etc. that take some amount of time to occur, may be represented as bars or lines 440-450 on the calendar spanning the time during which the communication occurred.

Furthermore, each graphical representation of a communication 435-450 may be selectable by the user. For example each graphical representation of a communication 435-450 may be clickable or otherwise selectable to cause additional information about that particular communication to be displayed.

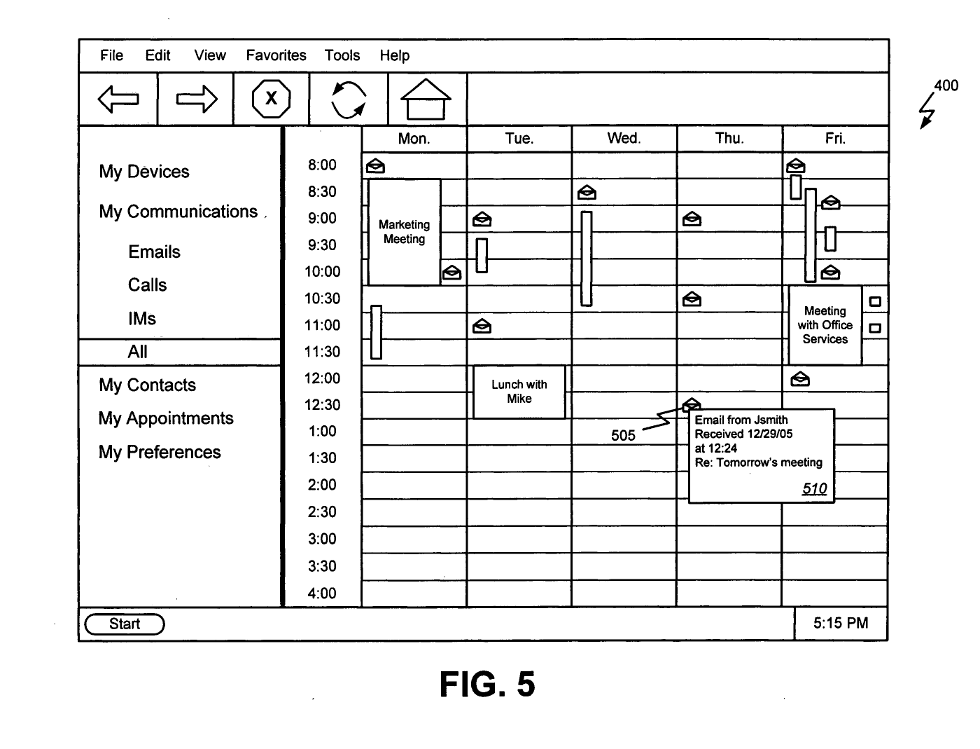

FIG. 5 illustrates the exemplary user interface for presenting communication records in a calendar perspective as illustrated in FIG. 4 with additional communication details according to one embodiment of the present invention. This example illustrates the user interface 400 of the previous example in which one of the communications 505 has been selected.

In response to the user selecting one of the graphical indications, such as by clicking on hovering over the graphical element 505 with a cursor or other control, additional details of the selected communication record can be displayed. In this example, displaying additional details of a communication selected by the user can comprise displaying a tooltip 510 including textual information from the communication record indicated by the selected graphical indication and further describing the communication. For example, the additional information may indicate a communication type, the other party to the communication, i.e., the sender or recipient, the time and or date received, the duration, if any, the subject, if discernable, etc.

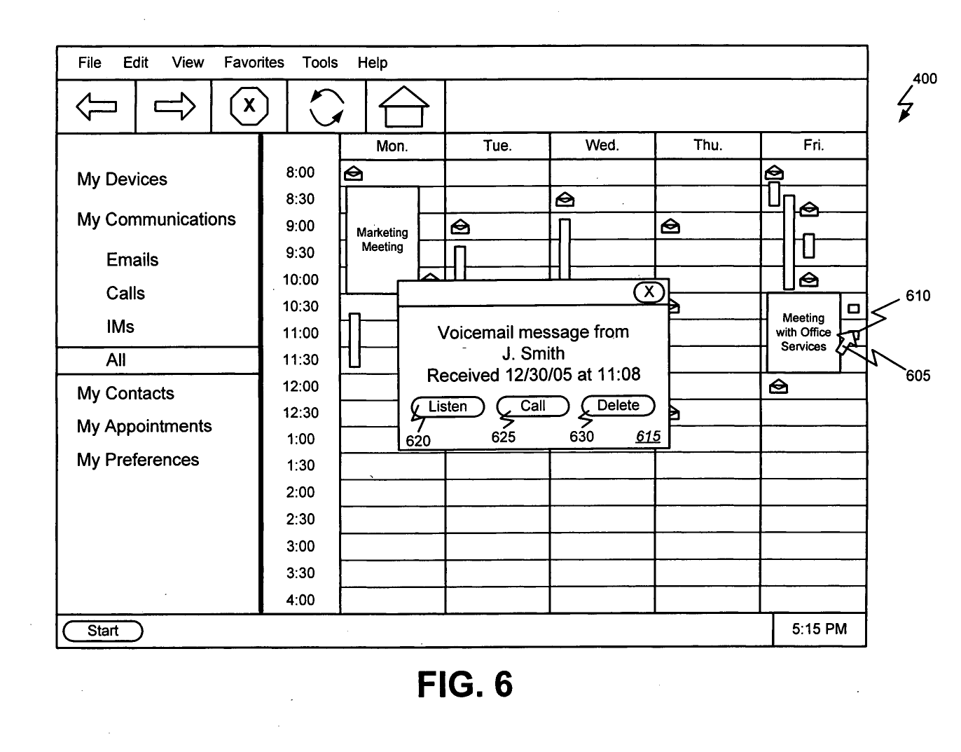

FIG. 6 illustrates the exemplary user interface for presenting communication records in a calendar perspective as illustrated in FIG. 4 with additional communication details according to an alternative embodiment of the present invention. This example illustrates the user interface 400 of the previous examples in which one of the communications 610 has been selected.

In response to the user selecting one of the graphical indications, such as by clicking on hovering over the graphical element 610 with a cursor 605 or other control, additional details of the selected communication record can be displayed. In this example, displaying additional details of a communication selected by the user can comprise displaying a pop-up window 615 including textual information from the communication record indicated by the selected graphical indication and further describing the communication. For example, the additional information may indicate a communication type, the other party to the communication, i.e., the sender or recipient, the time and or date received, the duration, if any, the subject, if discernable, etc.

Additionally, one or more options 620-630 for handling the communication record can be presented based on a type of communication represented by the selected communication record 610. For example, if the selected graphical element 610 represents a record of receipt of a voicemail message, the options 620-630 may include an option 620 to listen to the message, an option 625 to call the sender, an option 630 to delete the message, etc. These options 620-630 are shown here as clickable buttons but may be presented as hyperlinks or any other suitable element.

Additionally, while a tooltip and pop-up window are shown in FIGS. 5 and 6 respectively, other types of display elements may be used to present additional information about a communication record in response to the user selecting one of the graphical elements. For example an overlay may be used in a manner similar to either a tooltip or pop-up window. In another example, a textbox or other fixed element of the interface 400 may be used to display or scroll additional information from the communication record.

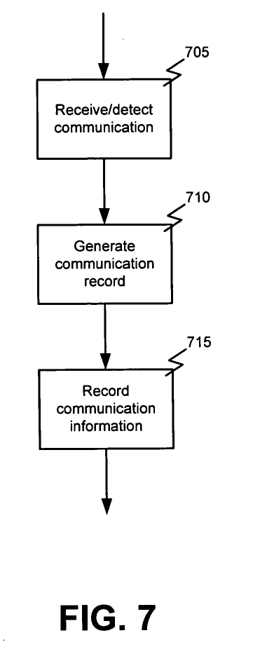

FIG. 7 is a flowchart illustrating a process for recording communications to be present in a calendar perspective according to one embodiment of the present invention. This example represents a process that may be performed by the service provider system discussed above with reference to FIG. 1, one or more of the servers or managers of the network element layer discussed above with reference to FIG. 2, or another system or device depending upon the environment in which the methods are implemented.

In this example, the implementing system can receive 705 or detect a communication to or from the user. As noted above, this can be accomplished by the implementing system monitoring communications for a given user or group of users. For example, one or more managers of the management layer described above with reference to FIG. 2 can monitor common language messages on the bus of the transport layer an detect common language messages, such as “InitiateCommunication” or other messages to or from the designated user(s).

Once a communication to or from the user has been detected 705, a new communication record can be generated 710 for the detected communications and information related to the communication can be recorded 715 in the new communication record. As noted above, the information related to the communication can include, but is not limited to, a communication type, a start time for the communication, an indication of the duration of the communication, and an indication of another party to the communication, etc. In other words, information related to the communication that may be helpful to the user in identifying the time and/or duration of the communication, nature or subject of the communication, parties to the conversation, etc. can be recorded to be made available for review by the user.

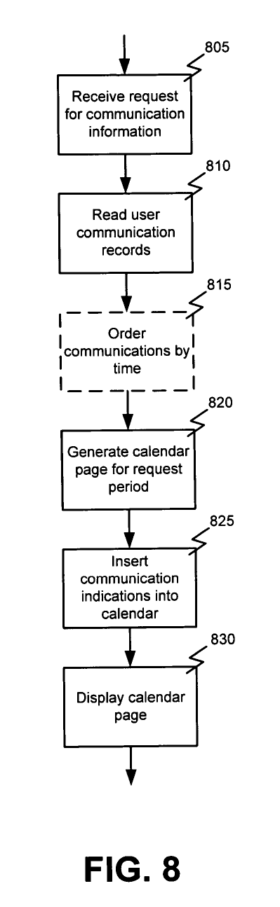

FIG. 8 is a flowchart illustrating a process for presenting communication records in a calendar perspective according to one embodiment of the present invention. This example represents a process that may be performed by the service provider system discussed above with reference to FIG. 1, one or more of the servers or managers of the network element layer discussed above with reference to FIG. 2, or another system or device depending upon the environment in which the methods are implemented and illustrates the processes performed by the initiating device as well as the recipient device.

In this example, the implementing system can receive 805 from a user a request to view communications to or from the user. That is, the user, through one of his end devices, can request a presentation of communication records. As noted above, the exact manner in which the user performs such operation can vary significantly depending upon the device and/or interface being used to make the request. Furthermore, the format of the request can also vary significantly depending upon the implementation. According to one embodiment, the request can identify the user and/or device making the request and in some case, as will be discussed below, may include additional information further defining the communication records requested.

One or more stored communication records can be read 810 from, for example, profile information or another data store associated with the user making the request. As described above with reference to FIG. 7, each record can represent a communication to or from the user and includes information related to the communication. Optionally, the communication records can be ordered 815 or sorted based on a time of occurrence of the communication determined from each of the communication records. Furthermore, the time of occurrence may be based on the start time of the communication as well as the duration or end time of the communication as indicated by the record(s).

A calendar page can be generated 820 for displaying the communication records. Such a page can comprise a webpage or other type of presentation depending upon the exact implementation. According to one embodiment, a calendar presented as a webpage. In such a case, generating 820 a calendar page can comprise generating a webpage based on static and/or dynamic HyperText Markup Language (HTML) or other such code.

A graphical indication for each of the communication records can be inserted 825 into the calendar page. That is, an icon, a bar, a line, or other graphical element, which may or may not include some textual elements, can be inserted into the calendar such as by elements being added dynamically to the HTML of the webpage representing the calendar.

The calendar page with the inserted graphical elements can then be presented 830 to the user. That is, the webpage or other representation of the calendar with the inserted elements representing the communication records can be sent to the user's end device, the user can be redirected to the calendar, etc.

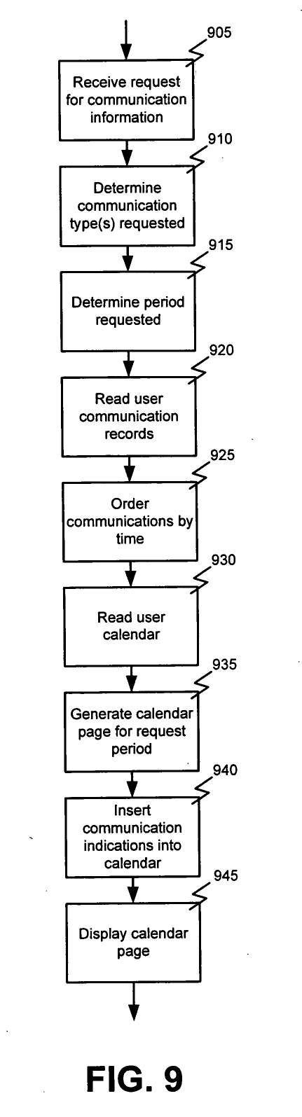

FIG. 9 is a flowchart illustrating additional details of a process for presenting communication records in a calendar perspective according to an alternative embodiment of the present invention. In this example, the implementing system can receive 905 from a user a request to view communications to or from the user. That is, the user, through one of his end devices, can request a presentation of communication records. As noted above, the exact manner in which the user performs such operation can vary significantly depending upon the device and/or interface being used to make the request. Furthermore, the format of the request can also vary significantly depending upon the implementation. According to one embodiment, the request can identify the user and/or device making the request as well as additional information further defining the communication records requested such as a time period, communication type, etc.

Therefore, in this example, one or more requested communication types can be determined 910 from the request to view communications. That is, the user may request to view phone calls to one, all, or some subset of all of his number, emails, IMs, all communications, etc. Furthermore, a requested time period can be determined 915 from the request to view communications. That is, the user may request to view communications occurring within a specified day, week, month, or other time period.

One or more stored communication records can be read 920 from, for example, profile information or another data store associated with the user making the request. As described above with reference to FIG. 7, each record can represent a communication to or from the user and includes information related to the communication. If, as in this example, the user has specified a communication type, reading the communication records can comprise reading one or more communication records representing communications of the requested communication types. Also, if the user has specified a time period, as in this example, reading the communication records can comprise reading one or more communication records representing communications occurring during the requested time period.

The communication records can be ordered 925 or sorted based on a time of occurrence of the communication determined from each of the communication records. Furthermore, the time of occurrence may be based on the start time of the communication as well as the duration or end time of the communication as indicated by the record(s).

One or more calendar items for the user can be read 930. That is, as discussed above, the calendar can include not only an indication of the communications but may also include one or more appointments, reminders, or other calendar items for the user. Such calendar items can be read 930, for example, from the user's profile information as discussed above.

A calendar page can be generated 935 for displaying the communication records and user calendar items. Such a page can comprise a webpage or other type of presentation depending upon the exact implementation. According to one embodiment, a calendar presented as a webpage. In such a case, generating 935 a calendar page can comprise generating a webpage based on static and/or dynamic HyperText Markup Language (HTML) or other such code. Furthermore, if the user has specified a time period, as in this example, generating 935 the calendar page can comprise generating a calendar page spanning the requested time period.

A graphical indication for each of the communication records can be inserted 940 into the calendar page. That is, an icon, a bar, a line, or other graphical element, which may or may not include some textual elements, can be inserted into the calendar such as by elements being added dynamically to the HTML of the webpage representing the calendar.

The calendar page with the inserted graphical elements can then be presented 945 to the user. That is, the webpage or other representation of the calendar with the inserted elements representing the communication records can be sent to the user's end device, the user can be redirected to the calendar, etc.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method of presenting records of communications in a calendar perspective, the method comprising:
receiving from a user a request to view communications to or from the user;
reading one or more stored communication records wherein each record represents a communication to or from the user and includes information related to the communication;
generating a calendar page for displaying the communication records; and
inserting a graphical indication for each of the communication records into the calendar page.

2. The method of claim 1, further comprising, prior to inserting the graphical indication for each of the communication records into the calendar page, ordering the communication records based on a time of occurrence of the communication determined from each of the communication records.

3. The method of claim 1, further comprising displaying the calendar page to the user.

4. The method of claim 1, further comprising determining one or more requested communication types from the request to view communications and wherein reading the communication records comprises reading one or more communication records representing communications of the requested communication types.

5. The method of claim 1, further comprising determining a requested time period from the request to view communications and wherein reading the communication records comprises reading one or more communication records representing communications occurring during the requested time period and generating a calendar page comprises generating a calendar page spanning the requested time period.

6. The method of claim 1, further comprising reading one or more calendar items for the user and wherein generating the calendar page comprises generating a calendar page including the one or more calendar items.

7. The method of claim 1, further comprising:
detecting a communication to or from the user;
generating a new communication record for the detected communications; and
recording information related to the communication in the new communication record.

8. The method of claim 7, wherein the information related to the communication comprises a communication type, a start time for the communication, an indication of the duration of the communication, and an indication of another party to the communication.

9. The method of claim 3, further comprising in response to the user selecting one of the graphical indications, displaying additional details of a communication record indicated by the graphical indication.

10. The method of claim 9, wherein displaying additional details of a communication selected by the user comprises displaying a tooltip including information from the communication record indicated by the selected graphical indication.

11. The method of claim 9, wherein displaying additional details of a communication record comprises displaying a pop-up window including information from the communication record indicated by the selected graphical indication.

12. The method of claim 9, wherein displaying additional details of a communication record comprises displaying an overlay including information from the communication record indicated by the selected graphical indication.

13. The method of claim 9, further comprising presenting one or more options for handling the communication record based on a type of communication represented by the communication record.

14. A system comprising:
a communications bus;
a user profile database communicatively coupled with the communications bus and adapted to maintain profile information for a plurality of users, the profile information including one or more communication records each representing a communication to or from the user and including information related to the communication;
at least one end device communicatively coupled with the communications bus and adapted to send and receive common language messages via the communications bus, to translate common language messages received from the communications bus to a format specific to the end device based on a device type, and to store user profile information in the user profile database;
a manager communicatively coupled with the communications bus and adapted to receive from the end device a request to view communications to or from a user of the end device, to read one or more stored communication records from the profile information for the user of the end device, to generate a calendar page for displaying the communication records, to insert a graphical indication for each of the communication records into the calendar page, and to send the calendar page to the end device via the bus.

15. The system of claim 14, wherein the end device is further adapted to receive the calendar page from the manager and to display the calendar page to the user.

16. The system of claim 14, wherein the manager is further adapted to read one or more calendar items from the profile information for the user of the end device and wherein generating the calendar page comprises generating a calendar page including the one or more calendar items.

17. The system of claim 14, wherein the manager is further adapted to:
detect a common language message to or from the user of the end device;
generate a new communication record for the detected common language message;
record information related to the common language message in the new communication record; and
store the new communication record in the profile information for the user of the end device.

18. The system of claim 17, wherein the information related to the communication comprises a communication type, a start time for the communication, an indication of the duration of the communication, and an indication of another party to the communication.

19. A machine-readable medium having stored thereon a series of instructions that, when executed by a processor, cause the processor to present records of communications in a calendar perspective by:
receiving from a user a request to view communications to or from the user;
reading one or more stored communication records wherein each record represents a communication to or from the user and includes information related to the communication;
generating a calendar page for displaying the communication records; and
inserting a graphical indication for each of the communication records into the calendar page.

20. The machine-readable medium of claim 19, further comprising displaying the calendar page to the user.

21. The machine-readable medium of claim 19, further comprising reading one or more calendar items for the user and wherein generating the calendar page comprises generating a calendar page including the one or more calendar items.

22. The machine-readable medium of claim 19, further comprising:
detecting a communication to or from the user;
generating a new communication record for the detected communications; and
recording information related to the communication in the new communication record.
